(19) United States
(12) Patent Application Publication
(10) Pub. No.: US 2025/0198848 A1
(43) Pub. Date: Jun. 19, 2025

(54) DEVICE AND METHOD FOR ELECTRICAL FAULT DETECTION

(71) Applicant: Caterpillar Inc., Peoria, IL (US)

(72) Inventors: Luvkush Govind Kumar, Mathura (IN); Siddartha Saikia, Chennai (IN); Robert A. Hamann, Tucson, AZ (US); Jeffrey P. Labre, Oro Valley, AZ (US); Mahendra Kumar Angamuthu Ganesan, Chennai (IN)

(73) Assignee: Caterpillar Inc., Peoria, IL (US)

(21) Appl. No.: 18/541,116

(22) Filed: Dec. 15, 2023

(51) Int. Cl. G01J 5/00; G01J 5/02; G01J 5/07

(52) U.S. Cl. CPC G01J 5/0096; G01J 5/0205; G01J 5/07; G01J 2005/0077

(57) ABSTRACT

A fault detection device includes a thermal camera that takes thermal images of an electrical system. The fault detection device includes a processor that receives thermal images of the electrical system from the thermal camera and processes a temperature of an electrical component of the electrical system from the thermal images. The processor also processes a predicted temperature of the electrical component from the current passing through the component and the ambient temperature. The health of the electrical component and faults in the electrical system can be determined from the temperature difference between the measured temperature of the electrical component and the predicted temperature of the electrical component.

### FIELD OF THE DISCLOSURE

The disclosure relates to the field of fault detection in electrical systems.

### BACKGROUND

In an event that an electrical component of an electrical system fails, it may result in damage to hardware or in the electrical system being shut down, and may pose a hazard to personnel using the electrical system. For example, a circuit breaker, contactor or fuse may short or undergo arcing.

It is known to monitor the temperature of electrical systems to detect faults in the electrical system. Conventionally, the temperature of the electrical system is compared to a threshold temperature to determine whether there is a fault in the electrical system. This provides a binary indication of whether or not a fault has occurred, and detects a fault only after it has occurred. In certain scenarios, this may provide an inaccurate indication of whether there is a fault in the electrical system. Typically, a separate thermal camera is required for each component that is being monitored, adding to the cost of a fault detection system.

### SUMMARY

Against this background, there is provided a fault detection device for an electrical system. The fault detection device comprises a thermal camera configured to acquire one or more thermal images of the electrical system. The fault detection device further comprises a processor configured to receive a thermal image of the electrical system from the thermal camera. The processor is further configured to determine a measured temperature of an electrical component using the thermal image; a current value of a current passing through the electrical component; an ambient temperature; a predicted temperature of the electrical component, wherein the predicted temperature is based on the current value and the ambient temperature; a temperature difference between the measured temperature of the electrical component and the predicted temperature of the electrical component; and the health of the electrical component based on the temperature difference.

In this way, the health of components of electrical systems can be determined. For example, the device can be used to determine whether a particular electrical component of the electrical system is healthy, has a fault or has a potential fault condition. The device may be used to locate a fault that has occurred within an electrical system by determining which electrical component has a fault. The device can be used to detect potential fault conditions prior to the fault occurring, so that corrective action may be taken before damage occurs. The device may be used to determine the cause of the potential fault condition or the fault.

There is also provided an electrical enclosure comprising an electrical system; a movable structure; a thermal camera mounted to the movable structure such that a field of view of the thermal camera is adjustable using the movable structure, wherein the thermal camera is configured to acquire one or more thermal images of the electrical system; and a processor configured to receive a thermal image of the electrical system from the thermal camera. The processor is further configured to determine: a measured temperature of an electrical component using the thermal image; a current value of a current passing through the electrical component; an ambient temperature; a predicted temperature of the electrical component; a temperature difference between the measured temperature of the electrical component and the predicted temperature of the electrical component; and the health of the electrical component based on the temperature difference.

There is also provided a method of fault detection for an electrical system. The method comprises acquiring a thermal image of the electrical system from the thermal camera; determining a measured temperature of an electrical component using the thermal image; determining current value of a current passing through the electrical component; determining an ambient temperature; determining a predicted temperature of the electrical component; determining a temperature difference between the measured temperature of the electrical component and the predicted temperature of the electrical component; and determining the health of the electrical component based on the temperature difference.

### BRIEF DESCRIPTION OF THE DRAWINGS

A specific embodiment of the disclosure will now be described, by way of example only, with reference to the accompanying drawings in which:

FIG. 1 shows a flowchart illustrating a method of fault detection according to an embodiment of the present disclosure.

FIG. 2 shows a flowchart illustrating inputs and an output of a model used in a method of fault detection according to an embodiment of the present disclosure.

### DETAILED DESCRIPTION

A fault detection device for an electrical system is provided according to an embodiment of the present disclosure. The fault detection device comprises a thermal camera configured to acquire one or more thermal images of the electrical system. The fault detection device further comprises a processor configured to receive a thermal image of the electrical system from the thermal camera. The processor is further configured to determine a measured temperature of an electrical component using the thermal image; a current value of a current passing through the electrical component; and an ambient temperature. Based on the current value and the ambient temperature, the processor is further configured to determine a predicted temperature of the electrical component. The processor is configured to determine a temperature difference between the measured temperature of the electrical component and the predicted temperature of the electrical component. Based on the temperature difference, the processor is configured to determine the health of the electrical component.

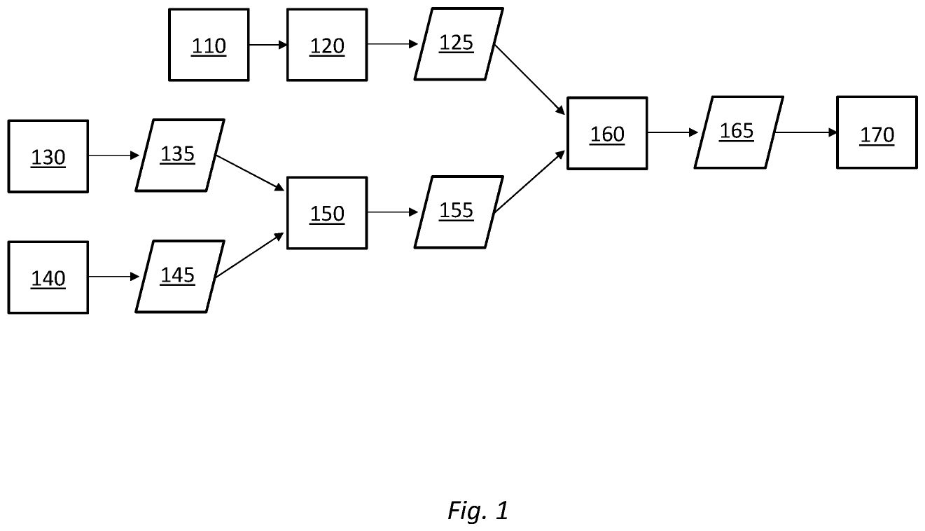

With reference to FIG. 1, a method of fault detection for an electrical system is illustrated. The method comprises acquiring a thermal image of the electrical system from the thermal camera at step 110. Using the thermal image, at step 120 the method comprises determining a measured temperature 125 of an electrical component. At step 130, a current value 135 of a current passing through the electrical component is determined. At step 140, an ambient temperature 145 is determined. Based on the current value 135 and the ambient temperature 145, at step 150 the method comprises determining a predicted temperature 155 of the electrical component. At step 160, the method comprises determining a temperature difference 165 between the measured temperature 125 of the electrical component and the predicted temperature 155 of the electrical component. At step 170, the health of the electrical component is determined based on the temperature difference 165. In the following description, any variations described to the functions of the fault detection device or to the functions of the processor of the fault detection device may also be variations to the method.

In certain embodiments, determining the health of an electrical component may comprise determining whether an electrical component is healthy or whether the electrical component has a fault. In certain embodiments, determining the health of an electrical component may comprise determining whether an electrical component is healthy or whether the electrical component has a potential fault condition. In certain embodiments, determining the health of an electrical component may comprise determining whether an electrical component is healthy, or whether the electrical component has a potential fault condition, or whether the electrical component has a fault. A potential fault condition may mean that the electrical component has not yet developed a fault but that the electrical component is at higher risk of developing a fault than a healthy component.

The processor may be configured to determine the health of more than one electrical component of an electrical system. The processor may be configured to determine the health of more than one electrical component shown in a thermal image, and/or to determine the health of electrical components shown in more than one thermal image. The processor may be configured to determine the health of the electrical components of an electrical system at regular intervals.

In certain embodiments, determining the health of the electrical component may comprise comparing the temperature difference to a threshold temperature difference. In an event that the temperature difference is below the threshold temperature difference, the electrical component may be determined to be healthy. In an event that the temperature difference is above the threshold temperature difference, a fault or other issue may have arisen in the electrical component, or a fault may be at risk of occurring. In this way, the location (specific electrical component in an electrical system) of a fault or predicted fault may be determined. In certain embodiments, the threshold temperature difference may be chosen such that a temperature difference above the threshold temperature difference is indicative of a fault already having occurred. In other embodiments, the threshold temperature difference may be chosen such that a temperature difference above the threshold temperature difference is indicative of a risk of a fault occurring (a potential fault condition), but not necessarily indicative of a fault that has already occurred. In certain embodiments, the temperature difference may be compared to more than one threshold temperature difference. For example, a first threshold temperature difference may be such that a temperature difference above the first threshold temperature difference is indicative of a risk of a fault occurring and a second threshold difference may be such that a temperature difference above the second threshold temperature difference is indicative of a fault occurring, wherein the second threshold temperature difference is higher than the first threshold temperature difference.

The processor may be further configured to provide a notification in an event that the temperature difference is above the threshold temperature difference. The notification may comprise one or more of a visible or audible notification, sending a message or signal to a processor or controller, sending an electronic or wireless message to an operator, or other notification.

The thermal camera may be movable such that a field of view of the thermal camera is adjustable. The thermal camera may be configured to obtain more than one thermal image of the electrical system, each of the more than one thermal images having a different field of view. In this way, thermal images of more than one electrical component of the electrical system may be obtained using the same thermal camera. In certain embodiments, the thermal camera may be configured to acquire thermal images with pre-determined fields of view. To achieve this, the movement of the thermal camera may be pre-determined. The positions of particular electrical components may be encoded into or stored in the thermal camera. In other embodiments, the thermal camera may use image recognition to move the thermal camera such that the field of view encompasses a particular electrical component or components. In certain embodiments, the thermal camera may be configured to obtain thermal images of the whole electrical system. In other embodiments, more than one thermal camera may be used, wherein each thermal camera is configured to acquire one or more thermal images of the electrical system. Each thermal camera may be movable such that a field of view of the thermal camera is adjustable.

In an event that the thermal camera acquires more than one thermal image of the electrical system, the processor may be configured to receive each thermal image of the electrical system from the thermal camera. For each thermal image, the processor may be further configured to determine a measured temperature of an electrical component using the thermal image; a current value of a current passing through the electrical component; and an ambient temperature. Based on the current value and the ambient temperature, the processor is further configured to determine a predicted temperature of the electrical component. The processor is configured to determine a temperature difference between the measured temperature of the electrical component and the predicted temperature of the electrical component. Based on the temperature difference, the processor is configured to determine the health of the electrical component. The processor may repeat this for each thermal image.

With reference to FIG. 1, the method illustrated may be repeated for each thermal image.

In certain embodiments, a given thermal image may show more than one electrical component. The processor may be further configured to determine a measured temperature of each electrical component shown in the thermal image. For each electrical component, the processor may be further configured to determine a measured temperature of the electrical component using the thermal image; a current value of a current passing through the electrical component; and an ambient temperature. Based on the current value and the ambient temperature, the processor is further configured to determine a predicted temperature of the electrical component. The processor is configured to determine a temperature difference between the measured temperature of the electrical component and the predicted temperature of the electrical component. Based on the temperature difference, the processor is configured to determine the health of the electrical component. The processor may repeat this for each electrical component shown in the thermal image.

The processor may be configured to determine one measured temperature for a given electrical component shown in a thermal image. The processor may be configured to determine more than one measured temperature for a given electrical component shown in a thermal image. The processor may be configured to perform image analysis to determine measured temperatures across the whole electrical component shown in a thermal image.

With reference to FIG. 1, method steps 120 to 170 may be repeated for each electrical component shown in the thermal image acquired in step 110.

In an event that the thermal image of the electrical system shows more than one electrical component, the processor may be configured to segment the thermal image into more than one image segment. An image segment may show an area of interest, wherein each area of interest comprises more than one electrical component, or one electrical component, or part of an electrical component. The processor may be configured to segment the thermal image in any suitable way. For example, the arrangement of the electrical system may be known and the field of view of the thermal image may be known. The location of area(s) of interest in the thermal image is therefore known. The processor may segment the thermal image based on the known location(s) of area(s) of interest, such that an image segment is known to show an area of interest. In another example, the processor may determine the location of an area of interest via image processing or other techniques, and may segment the thermal image such that an image segment shows the area of interest.

In an event that one or more image segments do not show an area of interest, the processor may not determine a temperature difference for those image segments without an area of interest.

In some examples, the area of interest may show a whole electrical component. In other examples, the area of interest may show part of an electrical component. For example, a particular electrical component may be partially thermally insulated. In an event that the part of the electrical component that is thermally insulated is thermally insulated with respect to the field of view of the thermal camera, the measured temperature of the insulated part of the electrical component may deviate significantly from the actual temperature of the electrical component. The measured temperature of the electrical component may vary between the insulated part of the electrical component and the non-insulated part of the electrical component. It may be beneficial to analyse different parts of the electrical component separately.

In certain embodiments, determining the measured temperature of an electrical component using a thermal image may rely on measuring the temperature at a particular location on the electrical component as shown in the thermal image. The temperature at the chosen location may be representative of the temperature of the electrical component. In other embodiments, determining the measured temperature of an electrical component using a thermal image may comprise determining the measured temperature at more than one location on the electrical component as shown in the thermal image. The measured temperatures may be averaged, or the distribution of the measured temperatures may be considered.

In certain embodiments, determining the measured temperature of an electrical component using a thermal image may comprise image analysis across the area of interest shown in the thermal image such that the temperature is measured across the whole electrical component, electrical components or part of electrical component shown in the area of interest. The processor may identify areas that have higher temperatures than other areas. In certain embodiments, the processor may identify the location and/or shape of the areas that have higher temperatures than other areas. The processor may determine the temperature difference for all or some of the measured temperatures across the area of interest. In certain embodiments, the processor may identify areas that have higher temperatures than other areas and may determine the temperature difference for those areas having higher temperatures. In other embodiments, the processor may determine the temperature differences for the whole electrical component (or electrical components or part of electrical component) shown in the area of interest.

For example, the processor may determine there to be more than one “hot-zone” on the electrical component (wherein a hot-zone is an area of the electrical component with a higher temperature than other areas of the electrical component). The processor may be configured to determine a measured temperature of each hot-zone, and subsequently determine a temperature difference between the measured temperature of each hot-zone and a predicted temperature. In an event that a first hot-zone of an electrical component has a temperature difference that is above a threshold temperature difference, the implication for the health of the electrical component may be different depending on the temperature difference of a second hot-zone of the electrical component. For example, an electrical component may be determined to have a first hot-zone and a second hot-zone. In an event that the temperature difference for both the first and second hot-zones is below a threshold temperature difference, the electrical component may be determined to be healthy. In an event that the temperature difference for the first hot-zone is above the threshold temperature difference and the temperature difference for the second hot-zone is below the threshold temperature difference, this may indicate that the electrical component has loose contact. Similarly, in an event that the temperature difference for the second hot-zone is above the threshold temperature difference and the temperature difference for the first hot-zone is below the threshold temperature difference, this may indicate that the electrical component has loose contact. In an event that the temperature difference for both the first and second hot-zones is determined to be above the threshold temperature difference, a different issue such as a phase imbalance might be determined to have occurred.

In another example, the processor may analyse the shape of a hot-zone. A certain shape of hot-zone may indicate that electrical arcing is occurring.

With reference to FIG. 1, the method may further comprise segmenting the thermal image acquired at step 110 into more than one image segment. For each image segment showing an area of interest, steps 120 to 170 may be carried out.

The thermal camera may be configured to repeat acquiring the thermal image or images of the electrical system at regular or irregular time intervals. The temperature difference for each electrical component shown in the thermal image(s) may be determined for thermal image(s) acquired at a given time point. At a later time point, thermal image(s) of the same electrical components may be acquired and the temperature difference for each electrical component shown in the thermal image(s) may be determined for thermal image(s) acquired at the later time point. This may be repeated.

As discussed, the thermal camera may be movable such that a field of view of the thermal camera is adjustable. In certain embodiments, the thermal camera may be rotatable about at least one axis. In certain embodiments, the fault detection device may further comprise a movable structure, wherein the thermal camera is mounted to the movable structure such that a lateral position of the thermal camera is adjustable using the movable structure. For example, the thermal camera may be movable in one or two dimensions using a frame.

The processor is configured to determine a predicted temperature of the electrical component, wherein the predicted temperature is based on the current value and the ambient temperature. In certain embodiments, the predicted temperature may be based on measured temperature data of a calibration electrical component. In certain embodiments, the predicted temperature may be based on a thermal model, wherein the current value and ambient temperature are inputs to the thermal model. The thermal model may be built based on measured temperature data of a calibration electrical component, or may be a physics-based model, or may be another type of model.

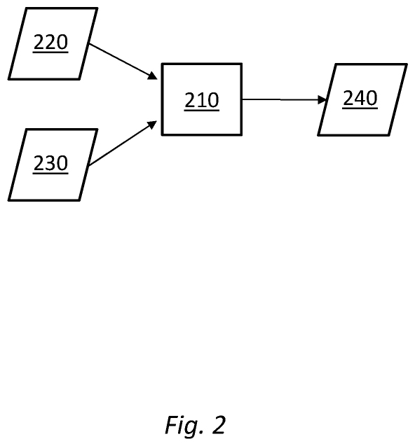

With reference to FIG. 2, a thermal model 210 for a particular electrical component may be configured to receive as inputs the current value 220 of a current passing through the electrical component and the ambient temperature 230. The thermal model 210 may output a predicted temperature 240 for that current value 220 and ambient temperature 230. The thermal model may indicate how predicted temperatures vary over time for a particular current value and ambient temperature.

The thermal model 210 may indicate predicted temperatures over time for various current values and ambient temperatures. The thermal model 210 may store predicted temperatures for specific combinations of current value and ambient temperature for a particular component. In an event that the input current value 220 and ambient temperature 230 are between stored values of current and temperature, the thermal model 210 may output the predicted temperature corresponding to the stored current value and ambient temperatures that are closest to the input current value 220 and ambient temperature 230. Otherwise, the thermal model 210 may extrapolate between more than one predicted temperature corresponding to stored current values and ambient temperatures that are adjacent or close to the input current value 220 and ambient temperature 230.

Alternatively, the thermal model 210 may store predicted temperatures as a function of current value and ambient temperature.

The thermal model 210 may be produced using a step current. Alternatively, the thermal model 210 may be produced using a current integrated within a time window. In use of the thermal model to output a predicted temperature, the input current value may be determined by integrating current over a time window. In certain examples, the time window may correspond to the settling time of the electrical system, wherein the settling time refers to the time taken for the current to reach a steady state following an input stimulus or command.

In certain embodiments, the thermal model 210 may be a physics-based model, such as a first order model. In certain embodiments, the thermal model 210 may be a data driven model, such as a machine learning based regression model.

The thermal model 210 may accept additional inputs. For example, a further input to the thermal model 210 may be an initial temperature of the electrical component. Other inputs may include one or more of an interrupting rating of the electrical system or component, an inrush current, a voltage drop, a load duty, a motor curve (for electrical systems related to a motor having constant torque or constant power), or other inputs.

In certain embodiments, the thermal model 210 is configured to output a predicted steady state temperature, disregarding transients. In other embodiments, the thermal model 210 may take transients into account. The initial temperature of the electrical component may be used as an input for a thermal model 210 that takes transients into account.

In the above, the processor is described as receiving a thermal image of the electrical system and determining a measured temperature. In certain embodiments, the processor may receive the thermal image and perform image analysis on said thermal image to determine the measured temperature of an electrical component. In other embodiments, the thermal image may include measured temperature information and the processor may determine the measured temperature directly from the included measured temperature information.

In certain embodiments, the processor as described herein may be one processor, controller or other processing device. In other embodiments, the processor as described herein may be more than one processor, controller or other processing device. For example, the image analysis (such as determining a measured temperature from the thermal image) and determining the predicted temperature may be carried out on the same processor or on different processors (such as a processor in the thermal camera for image analysis, and a different processor for determining the predicted temperature). Other processor configurations and combinations are possible.

According to an embodiment of the present disclosure, an electrical enclosure comprises an electrical system; a movable structure; a thermal camera; and a processor. The thermal camera is mounted to the movable structure such that a field of view of the thermal camera is adjustable using the movable structure, wherein the thermal camera is configured to acquire one or more thermal images of the electrical system. The processor is configured to receive a thermal image of the electrical system from the thermal camera. The processor is further configured to determine a measured temperature of an electrical component using the thermal image; a current value of a current passing through the electrical component; an ambient temperature; a predicted temperature of the electrical component; a temperature difference between the measured temperature of the electrical component and the predicted temperature of the electrical component; and the health of the electrical component based on the temperature difference. The movable structure may be configured to allow the thermal camera to be rotated about one or more axes, and/or to be translated.

1. A fault detection device for an electrical system, the fault detection device comprising:
a thermal camera configured to acquire one or more thermal images of the electrical system; and
a processor configured to receive a thermal image of the electrical system from the thermal camera and to determine:
a measured temperature of an electrical component using the thermal image;
a current value of a current passing through the electrical component;
an ambient temperature;
a predicted temperature of the electrical component, wherein the predicted temperature is based on the current value and the ambient temperature;
a temperature difference between the measured temperature of the electrical component and the predicted temperature of the electrical component; and
the health of the electrical component based on the temperature difference.

2. The fault detection device of claim 1, wherein the thermal camera is movable such that a field of view of the thermal camera is adjustable.

3. The fault detection device of claim 2, wherein the thermal camera is rotatable about at least one axis.

4. The fault detection device of claim 2, further comprising a movable structure, wherein the thermal camera is mounted to the movable structure such that a lateral position of the thermal camera is adjustable using the movable structure.

5. The fault detection device of claim 1 wherein the predicted temperature is based on measured temperature data of a calibration electrical component.

6. The fault detection device of claim 1, wherein the predicted temperature is based on a model and wherein the current value and ambient temperature are inputs to the model.

7. The fault detection device of claim 6 wherein the model is a physics-based model.

8. The fault detection device of claim 7 wherein the model is a first order model.

9. The fault detection device of claim 6 wherein the model is a data driven model.

10. The fault detection device of claim 9 wherein the model is a machine learning based regression model.

11. An electrical enclosure comprising:
an electrical system;
a movable structure;
a thermal camera mounted to the movable structure such that a field of view of the thermal camera is adjustable using the movable structure, wherein the thermal camera is configured to acquire one or more thermal images of the electrical system; and
a processor configured to receive a thermal image of the electrical system from the thermal camera and to determine:
a measured temperature of an electrical component using the thermal image;
a current value of a current passing through the electrical component;
an ambient temperature;
a predicted temperature of the electrical component;
a temperature difference between the measured temperature of the electrical component and the predicted temperature of the electrical component; and
the health of the electrical component based on the temperature difference.

12. The electrical enclosure of claim 11, wherein the movable structure is configured such that the thermal camera is rotatable about at least one axis.

13. The electrical enclosure of claim 11, wherein the movable structure is configured such that a lateral position of the thermal camera is adjustable using the movable structure.

14. A method of fault detection for an electrical system, the method comprising:
acquiring a thermal image of the electrical system from the thermal camera;
determining a measured temperature of an electrical component using the thermal image;
determining current value of a current passing through the electrical component;
determining an ambient temperature;
determining a predicted temperature of the electrical component;
determining a temperature difference between the measured temperature of the electrical component and the predicted temperature of the electrical component; and
determining the health of the electrical component based on the temperature difference.

15. The method of claim 14, wherein the thermal camera is movable such that a field of view of the thermal camera is adjustable.
